(19) United States
(12) Patent Application Publication
(10) Pub. No.: US 2003/0162934 A1
(43) Pub. Date: Aug. 28, 2003

(54) Phosphorus-containing epoxy monomer and hardening agent and composition thereof

(75) Inventors: Wen-Chiung Su, Taipei (TW); Jiang-Jen Lin, Taichung City (TW); Jun-Ren Wang, Tainan City (TW); Shi-Min Shau, Changhwa Hsien (TW); Ru-Jong Jeng, Taichung City (TW)

Correspondence Address: BACON & THOMAS, PLLC, 625 SLATERS LANE, FOURTH FLOOR, ALEXANDRIA, VA, 22314

(73) Assignee: Chung Shan Institute of Science & Technology, Taoyuan (TW)

(21) Appl. No.: 10/044,940

(22) Filed: Jan. 15, 2002

(51) Int. Cl. C08G 2/00

(52) U.S. Cl. 528/86

(57) ABSTRACT

The present invention discloses phosphorus-containing epoxy monomers of formula (I),

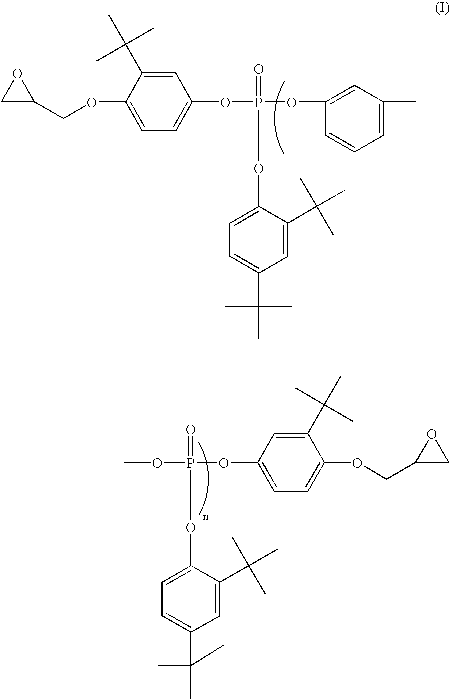

and a phosphorus-containing diamine hardening agent of formula (II),

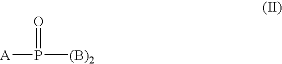

wherein A and B are defined as the specification. The present invention also discloses a phosphorus-containing flame-retardant epoxy composition including one or both of the phosphorus-containing epoxy monomers of formula (I) and the phosphorus-containing diamine hardening agent of formula

### BACKGROUND OF THE INVENTION

1. Field of the Invention

The present invention relates to a novel flame-retardant polymeric material and, more particularly, to phosphorus-containing flame-retardant epoxy monomers. The present invention also relates to a phosphorus-containing hardening agent. The present invention further relates to a phosphorus-containing epoxy composition including one or both of the above monomers and the hardening agent.

2. Description of the Related Technology

As one of the most popular materials, epoxy resin can be applied to transportation, electronic devices, computers, machines, constructions, aerospace, exercise equipment, etc. The epoxy material possesses a lot of advantages, such as electrical insulation, being excellently plastic, keeping constant shape, chemical resistance, adhesion to metal and ceramics, light weight, and low cost. Unfortunately, the epoxy resin is flammable like other plastics.

Recently, no-halogen-containing flame-retardant epoxy materials are widely investigated, wherein the phosphorus-containing compounds are particularly considered for flame retardment. The phosphorus-containing compounds have excellent characteristics of less stimulative or erosive gas generated, flame resistance, anti-oxidation, plastic, etc. Nevertheless, the technologies concerned with improving the epoxy material by the phosphorus-containing compounds still leave much to be desired.

### SUMMARY OF THE INVENTION

It is an object of the present invention to provide novel phosphorus-containing flame-retardant epoxy monomers.

It is another object of the present invention to provide a novel phosphorus-containing diamine hardening agent.

It is a further object of the present invention to provide a phosphorus-containing flame-retardant epoxy composition including one or both of the above monomers and hardening agent.

In the present invention, the novel phosphorus-containing flame-retardant epoxy monomer, bis(3-t-butyl-4-glycidyloxyphenyl-2,4-di-t-butylphenyl) resorcinol diphosphate (GDP), has a structural formula (I) as the follows:

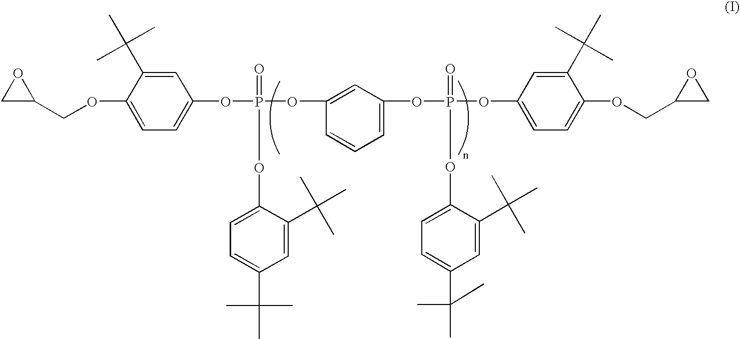

wherein n is 1 or 2.

The novel phosphorus-containing flame-retardant diamine hardening agent of the present invention has a structural formula (II) as the follows:

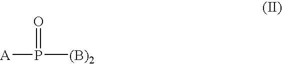

wherein

A is

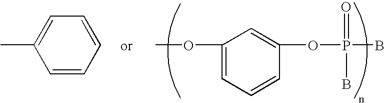

n is 1 or 2,

B is

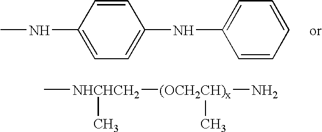

x is 2 or 3.

Examples of the novel phosphorus-containing flame-retardant diamine hardening agent of the present invention are the following formulae (II-1), (II-2), (II-3) and (II-4).

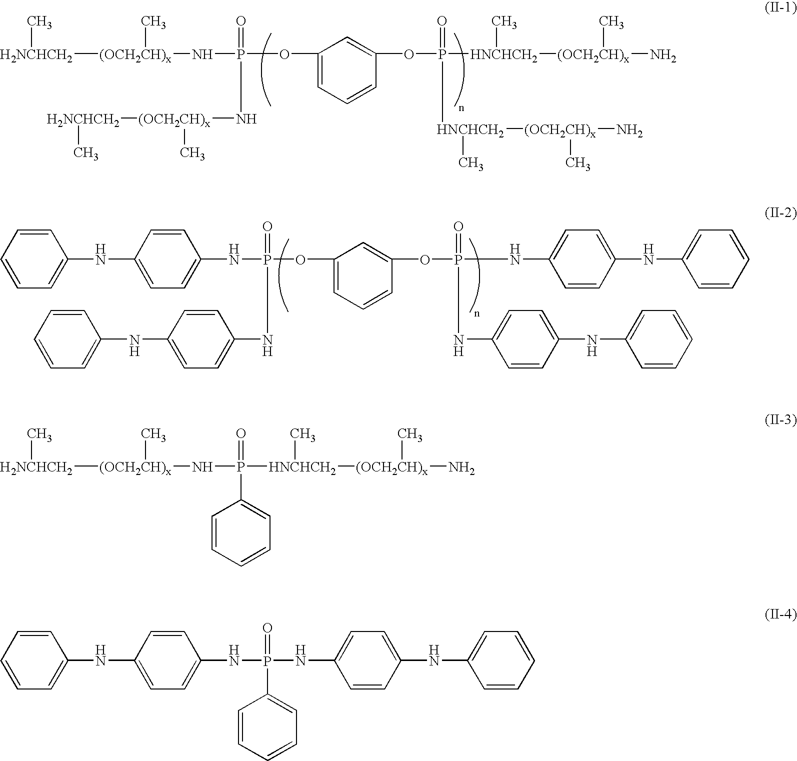

The novel phosphorus-containing flame-retardant epoxy compositions of the present invention may include one or both of the monomers and the hardening agent aforementioned.

The novel phosphorus-containing flame-retardant epoxy compositions of the present invention may include (a) the phosphorus-containing diamine hardening agent of formula (II) and (b) epoxy monomers, in which the epoxy monomers are not restricted and can be phosphorus-containing or no-phosphorus-containing.

The novel phosphorus-containing flame-retardant epoxy compositions of the present invention may include (a) a hardening agent and (b) the phosphorus-containing epoxy monomers of formula (I), in which the hardening agent is not restricted and can be phosphorus-containing or no-phosphorus-containing.

According to the novel phosphorus-containing flame-retardant epoxy monomers and the novel phosphorus-containing flame-retardant hardening agent disclosed in the present invention, anyone skilled in this art can produce a phosphorus-containing flame-retardant polymeric material by adding a proper amount of the phosphorus-containing flame-retardant epoxy compositions thereinto.

### DETAILED DESCRIPTION OF THE PREFERRED EMBODIMENTS

Scheme A shows synthesis of the phosphorus-containing flame-retardant epoxy monomers GDP, in which bis(3-t-butyl-4-hydroxy phenyl-2,4-di-t-butylphenyl) resorcinol diphosphate (HDP) and epichlorohydrin are heated and reacted under alkali condition. The above HDP is provided by Chung-Shan Institute of Science and Technology in Taiwan.

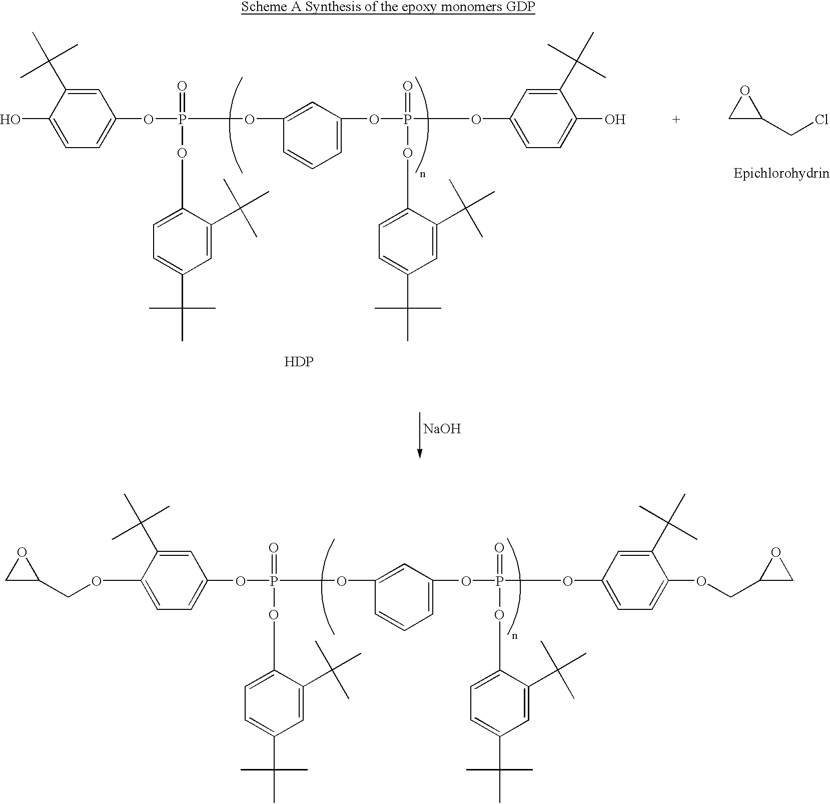

Scheme B shows synthesis of the novel phosphorus-containing flame-retardant hardening agent of the present invention, which includes:

(1) reacting tetrachloro resorcinol diphosphate (DCP) with poly(propylene glycol) bis(2-aminopropyl ether) (D230) to obtain the compound of formula (II-1);

(2) reacting DCP with N-phenyl-1,4-phenylenediamine (PDA) to obtain the compound of formula (II-2);

(3) reacting phenyl phosphonic dichloride (PPDC) with D230 to obtain the compound of formula (II-3); and

(4) reacting PPDC with PDA to obtain the compound of formula (II-4).

The above DCP is provided by Chung-Shan Institute of Science and Technology in Taiwan, D230 is provided by Huntsman Chemical Co., PPDC is provided by Aldrich Co, and PDA is provided by Forte Chemical Co. The epoxy monomers diglycidyl ether of biphenol A include BE-188 and NPES-901, wherein BE-188 having epoxy equivalence 188 g/eq is provided by Chang Chun Corporation and NPES-901 having epoxy equivalence 500 g/eq is provided by Nan Ya Plastic Co.

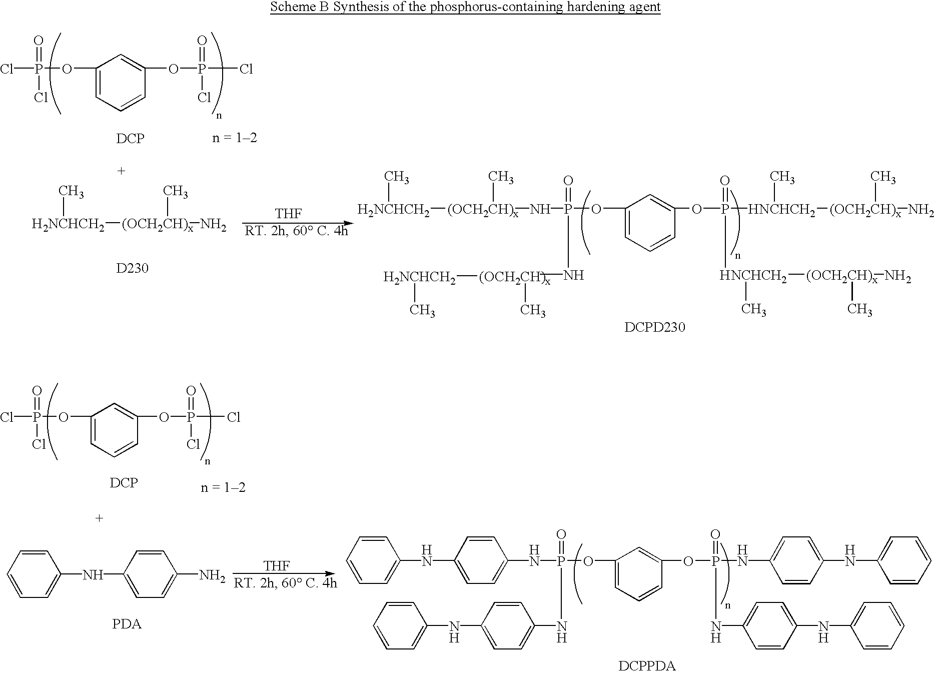

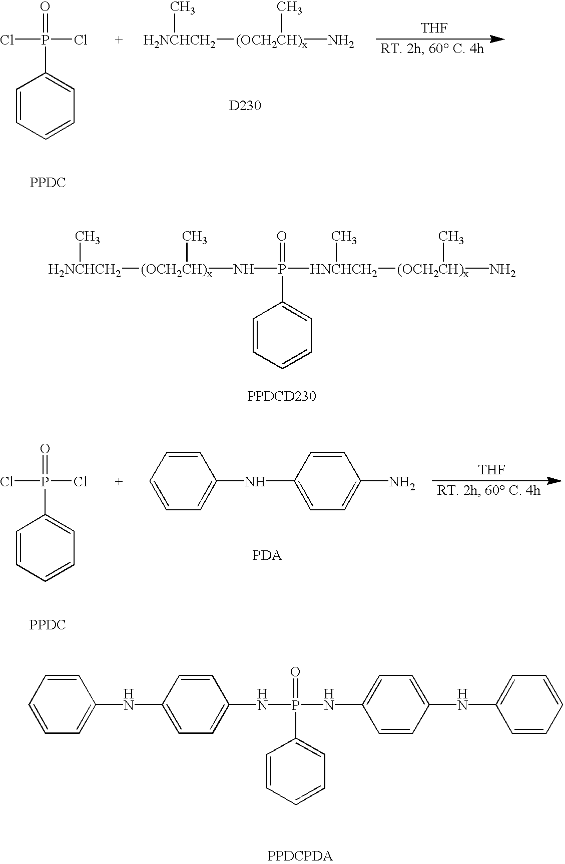

The flame-retardant epoxy compositions of the present invention can be used for producing the flame-retardant epoxy. Since the hardening reaction of the flame-retardant epoxy is not the point of the present invention and well known by those skilled in this art, it's not necessary to describe that in detail.

The flame-retardant epoxy compositions of the present invention are formed by reacting (a) the phosphorus-containing diamine hardening agent of formula (II) with (b) epoxy monomers. In such reaction, the mixing ratio is not restricted because the point is that the novel phosphorus-containing diamine hardening agent is applied thereto.

The flame-retardant epoxy compositions of the present invention can be also formed by reacting (a) a hardening agent with (b) the phosphorus-containing epoxy monomers of formula (I). Similarly, in such reaction, the mixing ratio is not restricted because the point is that the novel phosphorus-containing epoxy monomers are applied thereto.

The following examples can be used to illustrate the present invention but not to limit the scope thereof.

### EXAMPLE 1

Synthesis of the Phosphorus-Containing Epoxy Monomers (GDP) of formula (I)

HDP (80.0 g) and epichlorohydrin (320.0 g) are dissolved in a 500 ml three-necked flask and then slowly heated to 114-116° C. with reflux. Meanwhile, sodium hydroxide solution (5.15 g, 40 wt. %) is added through a funnel in 30 minutes. Next, the mixture is continuously heated with reflux for 15 minutes to form an interface of water/epichlorohydrin in an azeotropic separator. The interface is eliminated later. After heated for 2-3 hours, unreacted excessive epichlorohydrin is removed by pressure-reducing distillation. The product is dissolved in toluene, wherein the salts and impurities are removed by filtration. Finally, toluene is removed by pressure-reducing distillation, and the dark red and sticky phosphorus-containing epoxy monomers (GDP) of formula (I) are obtained. The yield is 93%.

### EXAMPLE 2

Synthesis of the Phosphorus-Containing Diamine Hardening Agent (DCPD230) of Formula (II-1)

D230 (5.6 g) and DCP (2.4 g) are respectively mixed with THF (50 ml). Next, the DCP mixture is slowly poured into the D230 mixture, and then stirred at room temperature for one hour and at 60° C. for 4 hours. Nitrogen is passed during the reaction to remove produced HCl. Most THF is removed by reducing pressure. In order to remove the residual HCl blending with the phosphorus-containing hardening agent, the phosphorus-containing hardening agent is dissolved in CHCl₃, then HCl in the organic layer is neutralized with NaHCO₃ solution, and finally the solvents are removed by extracting and reducing pressure, thereby the purified phosphorus-containing diamine hardening agent (DCPD230) of formula (II-1) is obtained. The yield is 60%.

### EXAMPLE 3

Synthesis of the Phosphorus-Containing Diamine Hardening Agent (DCPPDA) of Formula (II-2)

DCP (3.0 g) and N-phenyl-1, 4-phenylenediamine(PDA) (5.7 g) are dissolved in toluene to perform reaction. Toluene is then removed by distillation under reducing pressure. Next, the product is dissolved with ethanol, and HCl is removed by being adsorbed with aluminum oxide (1/10 weight of the product) and then filtered. Finally, ethanol is removed by reducing pressure, and the purified phosphorus-containing diamine hardening agent (DCPPDA) of formula (II-2) is obtained. The yield is 70%.

### EXAMPLE 4

Synthesis of the Phosphorus-Containing Diamine Hardening Agent (PPDCD230) of Formula (II-3)

D230 (35.4 g) and THF (150 ml) are added into a 300 ml round bottomed flask. Next, PPDC (10 g) dissolved in THF (50 ml) is dropwise added into the flask through a funnel at room temperature. The mixture is stirred for 2 hours and then heated to 60° C. for 4 hours for complete reaction. The mixture is then filtered and extracted with CHCl₃ and NaHCO₃ solution to neutralize produced HCl. Finally, the organic layer is separated and concentrated by reducing pressure to obtain the phosphorus-containing diamine hardening agent (PPDCD230) of formula (II-3). The yield is 65%.

### EXAMPLE 5

Synthesis of the Phosphorus-Containing Diamine Hardening Agent (PPDCPDA) of Formula (II-4)

PPDC (10 g) is first dissolved in toluene (50 ml) and then poured into a funnel. PDA (18.9 g) and THF (100 ml) are added into a 300 ml round bottomed flask. Next, PPDC in toluene is dripwise added into the flask at room temperature. The mixture is then stirred for 2 hours and then heated to 60° C. for 4 hours for complete reaction. The mixture is filtered and extracted with CHCl₃ and NaHCO₃ solution to neutralize produced HCl. The organic layer is then separated and concentrated by reducing pressure. After settling with methanol and dichloromethane, the phosphorus-containing diamine hardening agent (PPDCPDA) of formula (II-4) is obtained. The yield is 85%.

### EXAMPLE 6

Preparation of the Phosphorus-Containing Epoxy

The hardening agent of formula (II-1) is reacted with the monomers of formula (I) to obtain the epoxy containing 5.44% phosphorus and 2.26% nitrogen.

### EXAMPLES 7-11

Preparation of the Phosphorus-Containing Epoxy

Repeat the operation of Example 6, but replace the reactants with compounds listed in Table 1. Accordingly, different phosphorus-containing epoxies are obtained, and the phosphorus contents and nitrogen contents thereof are listed in Table 1.

TABLE 1

| | Hardening | | | TGA air | | TGA nitrogen | | |
|---|---|---|---|---|---|---|---|---|
| | agent/phosphorus- | Phosphorus | Nitrogen | | Char residue | | Char residue | |
| | containing | content | content | | at 850° C. | | at 850° C. | |
| | epoxy monomer | (%) | (%) | Td* (° C.) | (CR %) | Td* (° C.) | (CR %) | LOI |
| Example 6 | (II-1)/(I) | 5.44 | 2.26 | 262 | 8.3 | 257 | 21.8 | 30 |
| Example 7 | (II-2)/(I) | 6.19 | 3.12 | 236 | 12.0 | 232 | 29.9 | 32 |
| Example 8 | (II-3)/(I) | 5.31 | 2.17 | 239 | 12.4 | 250 | 18.1 | 29 |
| Example 9 | (II-4)/(I) | 5.96 | 3.75 | 205 | 13.4 | 205 | 22.6 | 30 |
| Example 10 | PDA/(I) | 4.80 | 1.67 | 263 | 18.2 | 283 | 26.8 | 30 |
| Example 11 | (II-2)/BE188 | 2.77 | 4.51 | 253 | 14.4 | 206 | 28.8 | 28 |
| Comparative | D230/NPES-901 | 0 | 1.34 | 248 | 5.4 | 340 | 5.4 | 18 |
| Example 1 | | | | | | | | |
| Comparative | D230/BE188 | 0 | 2.85 | 284 | 1.9 | 322 | 1.9 | 18 |
| Example 2 | | | | | | | | |
| Comparative | PDA/BE188 | 0 | 3.74 | 274 | 8.5 | 292 | 8.5 | 21 |
| Example 3 | | | | | | | | |

*Decomposition temperature taken at 5% weigh loss (heating rate = 10° C./min)

### Comparative Example 1

Preparation of Traditional Resin

Repeat the operation of Example 6, but replace the hardening agent with NPES-901 as listed in Table 1. Eventually, non-phosphorus-containing epoxy material is obtained by curing process, and the nitrogen content is listed in Table 1.

### Comparative Examples 2-3

Preparation of the Traditional Resin

Repeat the steps of Example 6, but replace the components with those listed in Table 1. Eventually, no-phosphorus-containing epoxies are obtained, and the phosphorus contents and the nitrogen contents are listed in Table 1.

In principle, better flame-retardant polymers can be judged from higher char yield and higher LOI (Limiting Oxygen Index) thereof. The char produced in burning and covering surfaces of the polymers can retard the polymers from flaming. LOI represents the least oxygen percentage required to keep the polymers burning and is usually compared with the air containing about 21% oxygen. Therefore, a material with LOI higher than 21% can be considered as uneasily getting burned in natural environment.

As listed in Table 1, the phosphorus-containing epoxies (Examples 6-11) of the present invention have relatively higher Residual Weight (%) than the traditional resins (Comparative Examples 1-3) at high temperature. Accordingly, the epoxies of the present invention are more flame-retardant because more char is formed to hinder the heat and oxygen transferring.

Furthermore, the LOI of the phosphorus-containing epoxies (Examples 6-11) can reach to 28-32, which indicates superior flame retardant of the present invention.

The examples aforementioned indeed show that the novel compounds of the present invention improve the characteristics of epoxy and thus can be applied to industries. However, it should be noticed that the above examples are used as illustrations, and the similar compositions analogized by those skilled in this art are still within the scope of the present invention.

What is claimed is:

1. A phosphorus-containing epoxy monomer of formula (I), 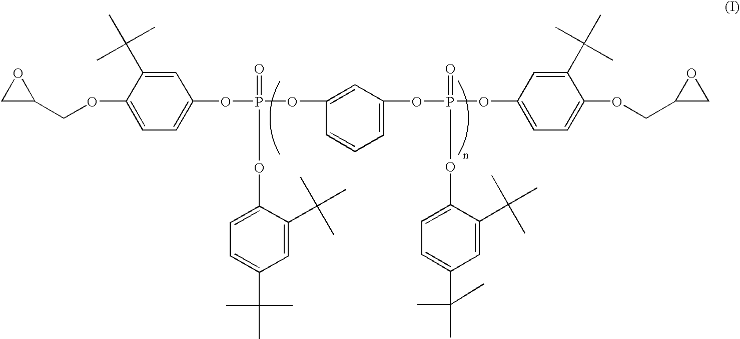
wherein n is 1 or 2.

2. A phosphorus-containing diamine hardening agent of formula (II): 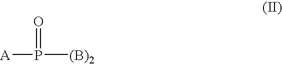
wherein
A is 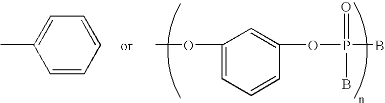
n is 1 or 2,
B is 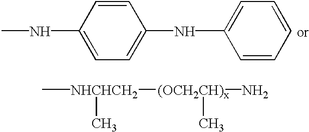
X is 2 or 3.

3. The hardening agent as claimed in claim 2, wherein A is the following group.

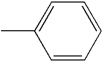

4. The hardening agent as claimed in claim 2, wherein A is the following group, 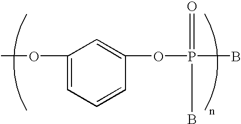
n and B is defined as claim 2.

5. The hardening agent as claimed in claim 2, which is a compound of formula (II-1).

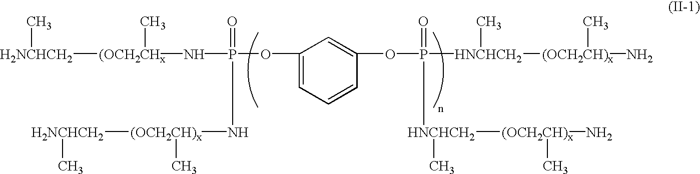

6. The hardening agent as claimed in claim 2, which is a compound of formula (II-2).

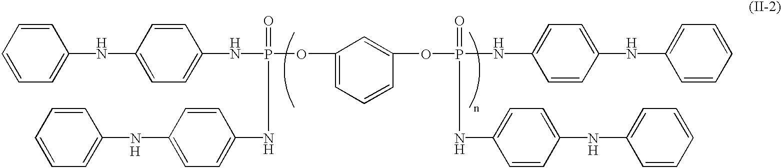

7. The hardening agent as claimed in claim 2, which is a compound of formula (II-3).

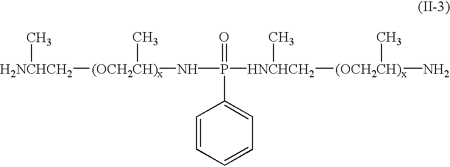

8. The hardening agent as claimed in claim 2, which is a compound of formula (II-4).

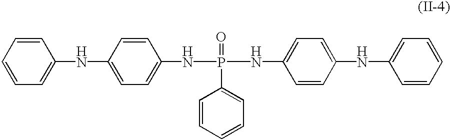

9. A flame-retardant epoxy compositions, comprising (a) formula (II) as claimed in claim 2 and (b) epoxy monomers.

10. The composition as claimed in claim 9, wherein said epoxy monomers are said phosphorus-containing epoxy monomers of formula (I) as claimed in claim 9.
